(19) United States
(12) Patent Application Publication
(10) Pub. No.: US 2017/0335250 A1
(43) Pub. Date: Nov. 23, 2017

(54) A POWDER DETERGENT FORMULATION

(71) Applicant: AQUAPHARM CHEMICALS PVT LTD., Pune, Maharashtra (IN)

(72) Inventors: Abhijit DESHPANDE, Pune, Maharashtra (IN); Uday GOKHALE, Mumbai, Maharashtra (IN)

(73) Assignee: AQUAPHARM CHEMICALS PVT LTD., Pune, Maharashtra (IN)

(21) Appl. No.: 15/534,206

(22) PCT Filed: Dec. 8, 2015
(86) PCT No.: PCT/IB2015/059433

§ 371 Date: Jun. 8, 2017

(30) Foreign Application Priority Data
Dec. 9, 2014 (IN) 3941/MUM/2014

(51) Int. Cl. C11D 7/32; C11D 17/00; C11D 3/37; C11D 17/06; C11D 3/36

(52) U.S. Cl. CPC C11D 7/3245; C11D 17/06; C11D 3/361; C11D 3/3776; C11D 17/0039

(57) ABSTRACT

The present disclosure relates to a powder detergent formulation. The present disclosure particularly relates to powder detergent formulation containing salts of amino alkyl carboxylates bearing secondary or tertiary amino group and three or more carboxyl groups.

### FIELD

The present disclosure relates to a powder detergent formulation.

### DEFINITIONS

As used in the present disclosure, the following terms are generally intended to have the meaning as set forth below, except to the extent that the context in which they are used indicate otherwise.

The expression ‘AACs’ for the purpose of the present disclosure refers to amino alkyl carboxylates bearing a secondary or tertiary amino group and three or more carboxyl groups.

The expression ‘GLDA’ for the purpose of the present disclosure refers to glutamic acid-N,N-diacetic acid.

The expression ‘I & I’ for the purpose of the present disclosure refers to industrial and institutional cleaning agents.

The expression ‘HEDP’ for the purpose of the present disclosure refers to hydroxyethylidene diphosphate.

The expression ‘PVP’ for the purpose of the present disclosure refers to polyvinylpyrrolidone (PVP), also commonly called polyvidone or povidone, is a water-soluble polymer made from the monomer N-vinylpyrrolidone.

### BACKGROUND

Amino alkyl carboxylates (AACs) bearing a secondary or tertiary amino group and three or more carboxyl groups are a class of chelating agents that can be used for applications such as in detergents, and as industrial and institutional cleaning agents. AACs are synthesized from the corresponding amino acids. Likewise, AACs synthesized from glutamic acid is glutamic acid-N,N-diacetic acid. GLDA is prepared by the condensation reaction of a metal salt of glutamic acid with sodium monochloroacetate. Such a reaction provides GLDA in the form of salts of the metal and sodium. Due to high biodegradability, GLDA is the most used AAC in detergents.

However, GLDA salts in the form of powders are hygroscopic in nature. For example, the alkali metal salts and alkaline earth metal salts of GLDA are hygroscopic. Further, in order to improve the cleaning effect of AACs, the AACs are often coated with metal chelating agents. However, the GLDA salts coated with metal chelating agents such as hydroxyethylidene-diphosphonate (HEDP) are also hygroscopic.

Due to their hygroscopic nature, GLDA salts are not suitable for preparation of stable powder formulations which can be used as detergents or as I and I cleaning agents. For effective application of AACs salts as detergents, as I and I cleaning agents, and in automatic dishwashers, stable powder formulations having reduced hygroscopicity are needed.

There is, therefore, felt a need to provide a powder formulation of AACs salts having reduced hygroscopicity.

### OBJECTS

Some of the objects of the present disclosure, which at least one embodiment herein satisfies, are as follows:

It is an object of the present disclosure to ameliorate one or more problems of the prior art or to at least provide a useful alternative.

Another object of the present disclosure is to provide a powder formulation comprising an AAC salt.

Still another object of the present disclosure is to provide a powder formulation comprising an AAC salt having reduced hygroscopicity.

Other objects and advantages of the present disclosure will be more apparent from the following description, which is not intended to limit the scope of the present disclosure.

### SUMMARY

The present disclosure relates to a stable powder detergent composition comprising a mixture of AACs salts. The AACs salt is at least one selected from the group consisting of glutamic acid-N,N-diacetic acid (GLDA) salts, ethylenediaminetetraacetic acid (EDTA) salts, and diethylene triamine pentaacetic acid (DTP A) salts. The mixture of AACs salts comprises at least one alkali metal salt of at least one AACs and at least one alkaline earth metal salt, which is coated with at least one polymeric component and at least one chelating agent.

The amount of the alkali metal salt of AAC ranges from 5% to 75% and the amount of alkaline earth metal salt ranges from 25% to 95% of the total weight of the formulation.

### DETAILED DESCRIPTION

Although GLDA, due to its biodegradability, is the most used amino alkyl carboxylates (AACs) having a secondary or tertiary amino group and three or more carboxyl groups, the conventionally used processes for preparing GLDA provides a solution of GLDA sodium salt.

GLDA salts in the form of powders are hygroscopic in nature. Further, in order to improve the cleaning effect of AACs, the AACs are often coated with metal chelating agents. However, the GLDA salts coated with metal chelating agents, such as, hydroxyethylidene-diphosphonate (HEDP) are also hygroscopic.

Due to the hygroscopic nature, the GLDA salts are not suitable for preparation of stable powder formulations which can be used as detergents or as I and I cleaning agents. For effective applications of AAC salt as detergents, I and I cleaning agents, and in automatic dish washers, stable powder formulations having reduced hygroscopicity are needed/required.

Therefore, the inventors of the present disclosure envisaged powder formulations of GLDA having reduced hygroscopicity.

In one aspect of the present disclosure there is provided stable powder formulations comprising a mixture of AACs salts; wherein the mixture of salts contains:
(a) at least one alkali metal salt of at least one AAC; and
(b) at least one alkaline earth metal salt.
   wherein, the mixture of AACs salts is in the form of powder, coated with at least one polymeric component and at least one chelating agent.

The AACs salts is at least one selected from the group consisting of glutamic acid-N,N-diacetic acid (GLDA) salts, ethylenediammetetraacetic acid (EDTA) salts, diethylene triamine pentaacetic acid (DTP A) salts, and the like.

The amount of the alkali metal salt of AACs ranges from 5% to 75% of the total weight of the formulation. The alkali metal ion in the alkali metal salt of AACs is selected from the group comprising sodium and potassium. In an exemplary embodiment, the alkali metal ion in the alkali metal salt of AACs is sodium.

The amount of the alkaline earth metal salt of AACs ranges from 25% to 95% of the total weight of the formulation. The alkaline earth metal ion in the alkaline earth metal salt of AACs includes, but is not limited to, calcium and magnesium. In an exemplary embodiment, the alkaline earth metal ion in the alkaline earth metal salt of AAC is calcium.

Further, the mixture of AACs salts is coated with at least one polymeric component and at least one chelating agent.

The coating comprises a predetermined amount of the polymer component and predetermined amount of the chelating agent/s.

The polymeric component is at least one polymer or at least one copolymer or a combination of polymer and copolymer. The polymeric component includes, but is not limited to, alkyl polymers, copolymers of acrylic maleic acids, and polymers prepared from the monomer/s selected from the group comprising substituted or unsubstituted C₁ to C₁₀ alkyl compounds, substituted or unsubstituted C₁ to C₁₀ cycloalkyl compounds, and substituted or unsubstituted C₁ to C₁₀ heterocyclic compounds.

The alkyl polymer includes, but is not limited to, polyvinyl pyrrolidone (PVP) and ethoxylates of long chain alcohols, such as, cetostearyl alcohol. In an exemplary embodiment, the polymer is PVP. The acrylic maleic acid copolymers comprise an acrylic acid component and a maleic acid component; wherein the acrylic acid component is in the range from 30 to 50% of the total weight of the copolymer; and the maleic acid component is in the range from 50 to 70% of the total weight of the copolymer.

The chelating agent is hydroxyethylidene-diphosphonate (HEDP). Other chelating agents may be selected from alkyl phosphonic acids.

In another aspect of the present disclosure, there is provided a process for preparing a stable powder formulation comprising a mixture of AACs salts. The process is described in detail herein below:

An aqueous solution (first aqueous solution) comprising at least one alkali metal salt of AAC is obtained by mixing at least one compound selected from the group consisting of AAC and at least one alkali metal.

In an exemplary embodiment, the AAC compound is GLDA. The alkali metal ion in the alkali metal salt of AACs includes, but is not limited to, sodium and potassium. In an exemplary embodiment, the alkali metal salt of GLDA is the sodium salt of GLDA.

The first aqueous solution is then reacted with at least one alkaline earth metal salt, and the resultant solution is filtered to obtain a second aqueous solution containing a mixture of salts of AACs. In an embodiment of the present disclosure, the alkaline earth metal salt is used in the form of an aqueous solution. The amount of the alkaline earth metal salt used is such that it can replace 25% to 95% of the alkali metal ion from the AACs salt in the first aqueous solution.

The alkaline earth metal salt includes, but is not limited to, the halides of calcium and magnesium. In an exemplary embodiment of the present disclosure, the alkaline earth metal salt is calcium chloride. The amount of the alkaline earth metal salt used is such that it can replace 5% to 75% of the alkali metal ion from the AACs salt in the first aqueous solution.

In an exemplary embodiment, the second aqueous solution contains AACs of 2.0 mole to 3.0 mole equivalents of the alkali metal ions, and 0.5 to 1.0 mole equivalents of the alkaline earth metal ions.

The second aqueous solution comprising the mixture of AACs salts is spray-dried to obtain powder of AACs. The spray drying is carried out at a temperature in the range from 100° C. to 225° C.

The mixture of AACs salts obtained after spray drying (powder) is further coated with at least one polymeric component and at least one chelating agent to obtain the powder formulation.

It is found that the powder containing mixture of AACs salt coated with a chelating agent and a polymeric component provides a powder formulation which is non-hygroscopic in nature, and therefore stable. This powder formulation is suitable for applications such as automatic dish washers, detergents, and I and I cleaning agents.

The present disclosure is further described in light of the following experiments which are set forth for illustration purpose only and not to be construed for limiting the scope of the disclosure. The following experiments can be scaled up to industrial/commercial scale, and the results obtained can be extrapolated to industrial scale.

It is observed that, the mixed GLDA salt solution containing 0.5 mole of Ca per mole GLDA is stable at 40% concentration of the salt, and the mixed GLDA salt solution containing 0.75 mole of Ca per mole GLDA is stable at 30% concentration of the salt.

### EXPERIMENTAL DETAILS

### Experiment 1

### Process of Preparation of Powder Detergent Formulation in Accordance With the Present Disclosure

### Step 1: Preparation of Mixture of Salts of Glutamic Acid-N,N′-Diacetic Acid (GLDA):

The calcium and sodium salts of Glutamic acid-N,N′-diacetic acid (GLDA) were prepared with different molarities are listed as follows:
(a) 0.75 M Ca/Na: 30% Solution; and
(b) 0.5 M Ca/Na: 30% Solution

### (a) 0.75 M Ca/Na (30% Solution) of Calcium and Sodium Salts of Glutamic Acid-N,N′-Diacetic Acid (GLDA):

A round bottom flask, equipped with an overhead stirrer and a thermometer, was charged with 2706 gm ((46% w/w) and (3.546 M)) of tetra sodium salt of Glutamic acid-N,N′-diacetic acid (GLDA acid) and 2561 ml of water at 26° C. (an ambient temperature), under stirring.
775 gm of ((38% w/w) and (2.653 M)) aqueous solution of CaCl2 was added slowly to the above solution over 2 to 3 hours at 30° C. to obtain 6042 gm of a clear pale yellow colored reaction mass.
The reaction mass was filtered and the filtrate (6040 gm) was stored at 26° C. for 3 days.

### (b) 0.5 M Ca/Na (40% Solution) of Calcium and Sodium Salts of Glutamic Acid-N,N′-Diacetic Acid (GLDA):

A round bottom flask, equipped with an overhead stirrer and a thermometer, was charged with 4307 gm ((39% w/w) and (4.798 M)) of tetra sodium salt of Glutamic acid-N,N′-diacetic acid (GLDA acid) and 1105 ml of water at 26° C. (an ambient temperature), under stirring.
711 gm of ((38% w/w) and (2.443 M)) aqueous solution of CaCb was added slowly to the above solution over 2 to 3 hours at 30° C. to obtain 6123 gm of a clear pale yellow colored reaction mass.
The reaction mass was filtered, and the filtrate (6122 gm) was stored at 26° C. for 3 days. An aqueous solution containing a mixture of alkali metal salt and alkaline earth metal salt of GLDA was prepared with 0.5 moles of Calcium per mole of GLDA and with 0.75 moles of Calcium (Ca) per mole GLDA were prepared and analyzed.

### Step 2: Spray Drying

The solutions obtained in Step-1 were spray-dried under conditions provided herein below.

TABLE 1
Spray drying of the solution

| | GLDA | | GLDA | |
|---|---|---|---|---|
| Parameter | Ca: 0.5 Na: 3 | | Ca: 0.75 Na: 2.5 | |
| Feed storage temperature | 30° | C. | 30° | C. |
| Inlet temperature | 210° | C. | 210° | C. |
| Outlet temperature | 110° | C. | 110° | C. |
| Additional air pressure | NIL | | NIL | |
| used | | | | |
| Nozzle size | 1.0 | mm | 1.0 | mm |

The analysis of the powder formulation is provided in Table 2.

TABLE 2
Analysis of the powder

| | GLDA | GLDA |
|---|---|---|
| | Ca: 0.5 moles | Ca: 0.75 moles |
| Parameter | Na: 3 moles | Na: 2.5 moles |
| Appearance | Off white powder | Off white powder |
| Odor | Nil | Nil |
| Fe sequestration | 102 | 98 |
| Activity as GLDA by Fe | 64.5 | 62.08 |
| sequestration | | |

### Calcium Content 3.91% 5.51%

### Moisture 6.55% 6.29

pH (1% solution) 10.59 10.61
Step 3: Coating with Polymeric Component and Chelating Agents
The powder obtained in step-2 was uniformly coated with hydroxy-ethylidene-diphosphonate and PVP by spray drying to form uniformly coated powder composition.
Hygroscopicity: A sample was kept in petri-dishes open to air for 24 hours. The coated powder obtained from this treatment is found to be non-hygroscopic.
Control Experiment: Coating with a chelating agent alone
The powder obtained in step-2 was uniformly coated by spray drying the powder using HEDP.
Hygroscopicity: The coated powder obtained from this treatment is found to be hygroscopic in nature.

### Technical Advancements

The present disclosure described herein above has several technical advantages including, but not limited to, the realization of:
a process for the preparation a stable powder formulation comprising a mixture of an alkali metal salt and an alkaline-earth metal salt of AACs; and
a coated powder formulation having reduced hygroscopicity and improved stability which is suitable for automatic dish washers, detergents, and I and I cleaning agents.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results. While certain embodiments of the inventions have been described, these embodiments have been presented by way of example only, and are not intended to limit the scope of the inventions. Variations or modifications to the formulation of this invention, within the scope of the invention, may occur to those skilled in the art upon reviewing the disclosure herein. Such variations or modifications are well within the spirit of this invention.

The numerical values given for various physical parameters, dimensions and quantities are only approximate values and it is envisaged that the values higher than the numerical value assigned to the physical parameters, dimensions and quantities fall within the scope of the invention unless there is a statement in the specification to the contrary.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

We claim:

1. A stable powder detergent formulation comprising a mixture of amino alkyl carboxylates (AACs) salts, wherein said mixture of salts contains:
a. at least one alkali metal salt of at least one AACs; and
b. at least one alkaline earth metal salt.

2. The stable powder detergent as claimed in claim 1, wherein said AACs salt is at least one selected from the group consisting of glutamic acid-N,N-diacetic acid (GLDA) salts, ethylenediaminetetraacetic acid (EDTA) salts and diethylene triamine pentaacetic acid (DTP A) salts

3. The stable powder detergent as claimed in claim 1, wherein the amount of said alkaline earth metal salt ranges from 25 wt % to 95 wt % of the total weight of the formulation.

4. The stable powder detergent as claimed in claim 1, wherein the amount of said alkali metal salt ranges from 5 wt % to 75 wt % of the total weight of the formulation.

5. The stable powder detergent as claimed in claim 1, wherein said alkaline earth metal salt is at least one selected from the group consisting of calcium and magnesium.

6. The stable powder detergent as claimed in claim 1, wherein said alkali metal salt is at least one selected from the group consisting of sodium and potassium.

7. A process for preparing a stable powder detergent formulation comprising a mixture of AACs salts, involving the following steps:
(i) providing a first aqueous solution containing at least one compound selected from the group consisting at least one alkali metal salt of at least one AAC;
(ii) reacting the first aqueous solution with at least one alkaline earth metal salt and filtering the resultant solution to obtain a second aqueous solution containing a mixture of salts of AACs;
(iii) spray-drying the second aqueous solution to obtain the mixture of AACs salts in the form of powder; and
(iv) coating the mixture of AACs salts in the form of powder with at least one polymeric component and at least one chelating agent to obtain the stable detergent powder formulation.

8. The process as claimed in claim 7, wherein said spray drying of the second aqueous solution is carried out at a temperature in the range from 100° C. to 225° C.

9. The process as claimed in claim 7, wherein said polymeric component is at least one polymer selected from the group consisting of alkyl polymers, copolymers of acrylic maleic acids and polymers prepared from monomers selected from the group comprising substituted or unsubstituted C₁ to C₁₀ alkyl compounds, substituted or unsubstituted C₁ to C₁₀ cycloalkyl compounds and substituted or unsubstituted C₁ to C₁₀ heterocyclic compounds.

10. The process as claimed in claim 7, wherein said chelating agent is hydroxyethylidene-diphosphonate (HEDP).
